(19) United States
(12) Patent Application Publication
(10) Pub. No.: US 2008/0277613 A1
(43) Pub. Date: Nov. 13, 2008

(54) Valve

(75) Inventors: Christopher Paul Ramsey, Wantage (GB); Antonio Gonzalez, Barcelona (ES); Bernard Guglielmini, Crimolois (FR); Sylvia Maria Farrow, Oxford (GB)

Correspondence Address: Nixon Peabody, 401 9th Street N W, Suite 900, Washington, DC, 20004-2128, US

(73) Assignee: Roemerstrasse 83, Reinach (CH)

(21) Appl. No.: 11/632,485

(22) PCT Filed: Jul. 18, 2005
(86) PCT No.: PCT/EP05/53441

§ 371 Date: Dec. 11, 2007

(30) Foreign Application Priority Data
Jul. 16, 2004 (EP) 04254285.2

(51) Int. Cl. F16K 5/08

(52) U.S. Cl. 251/309

(57) ABSTRACT

A valve for use as a fluid flow regulator having an inner part (20) and an outer part (10), which are moveable relative to one another. At least one of the inner or outer parts is connected to a source of fluid. One of the parts is fixed whilst the other is movable and the outer part has at least one orifice (16), through which fluid may be dispensed when the valve is “open”. The moveable part is free to rotate about its axis, but axial movement is prevented and when the valve is in its closed position, the inner part (20) and the outer part (10) are arranged relative to one or more sealing olives (40) to prevent fluid from flowing axially over the sealing olive (40) and out through the orifice (16). The sealing olive (40) may be arranged on either or both of the inner or outer parts.

This invention relates to a valve for regulating the flow of a fluid. Although the valve may be used for other purposes, for the ease of explanation one embodiment will be described with regard to its use as a dispensing valve, wherein the dispensing valve is associated with a container containing a fluid to be dispensed.

Such a dispensing valve is known from patent

### FR 2732316.

This dispensing valve comprises a fixed part, forming the dispensing valve body, adapted for attachment to a container. This fixed part extends away from the container in a generally cylindrical shape and is open at its two axial ends. The fixed part is also pierced by a lateral fluid outlet orifice and an air inlet orifice. These two orifices are positioned approximately opposite each other in the walls of the fixed part. The dispensing valve furthermore comprises a moveable part, which has a closure part of generally cylindrical shape, which is tightly fitted inside the fixed part. This moveable piece is open at its internal axial end. In the generally cylindrical wall of this moveable part are two cutouts positioned approximately opposite each other. The external axial end of the moveable part is closed by a plate, which extends radially beyond the generally cylindrical wall thus providing a rim, which may be gripped by a user. A seal is created between the cylindrical walls of the tightly fitted inner moveable part and the outer fixed part.

Accordingly, when the cutouts of the moveable inner part are completely out of radial and/or axial alignment with the orifices of the fixed outer part no fluid may pass from the container to the outside via either of the orifices.

This known dispensing valve further comprises a tamper evident band, which is located in the form of a skirt between the radially distal edge of the plate and the fixed outer part. This tamper evident band prevents the inner moveable part from being moved, from its initial position, in relation to the outer fixed part of the dispensing valve.

In use, the tamper evident band is first removed. This allows the user to pull the inner moveable part axially away from the outer fixed part. By doing this, the two cut-outs in the wall of the inner moveable part are positioned axially in line with the two orifices in the outer fixed part. The user may then twist the inner moveable part causing the two cut-outs to line up radially with the two orifices. Thus when the fluid is brought into contact with the dispensing valve by means of tilting of the container or squeezing of the walls of the container, the fluid in the container may pass through the outlet orifice and air may enter the container through the inlet orifice. To regulate the flow of fluid the inner moveable part may be twisted so that more or less of the cut-outs and orifices radially line up.

When the desired amount of fluid had been dispensed the user must twist the inner moveable part relative to the outer fixed part so that the cut-outs and the orifices are radially out of alignment. Although this closes the container, for a better seal the user must then push the inner moveable part axially back towards the container.

A first drawback of this dispensing valve is that two hands are required to initially operate it, since the outer fixed part must be braced while the inner moveable part is pulled out. A second drawback is that the user must undertake two actions in order to provide a route for the fluid to reach the orifice. The first action is to pull the inner moveable part axially away from the fixed outer part, and the second action is to twist the inner moveable part relative to the fixed outer part. After use, the user must rotate the inner moveable part relative to the outer fixed part and then push the inner moveable part axially into the outer fixed part to reseal the container.

U.S. Pat. No. 3,690,520.
describes a similar valve arrangement in which the valve must be pulled axially to bring the dispensing orifices in an inner and outer part into axial alignment, before being twisted to align the orifices radially so that fluid may be dispensed from the container. This valve suffers from the same drawback described above.

### WO 0030949.

and

### DE 9016299 U.

describe an alternative arrangement in which movement of the valve again has two components (an axial component and a rotational component), but movement of the valve between its open and closed positions is effected by means of a screw thread arrangement. The screw thread arrangement provides both rotational and axial components of movement simultaneously and therefore a single twisting motion allows the orifices to be aligned both axially and rotationally in much the same way as described above. This arrangement has the advantage that a user may open the valve using a single twisting motion. However the disadvantage of all the valves described above is that upon opening, the axial length of the valve must increase. This is un-desirable where space is restricted (for example when the container/valve is stored in a refrigerator) or where the valve is prone to receiving an impact whilst open.

The object of the present invention is to provide a valve, which may be used for regulating the flow of a fluid, wherein the drawbacks described above are overcome. In other words, the present invention provides a valve, which may be operated by only one hand, where only one action is required to provide a route for the fluid to reach the orifice and where the axial length of the valve remains fixed. The valve may be used for dispensing fluid held in a container. However, the use of the word container should be understood to also include a pipe or other body, which may carry a moving or stationary fluid, as well as a common bottle, which holds a stationary fluid.

Accordingly, the invention provides a valve for use as a fluid flow regulator, comprising an outer part (10,210, 410) having at least one orifice (16), an inner part (20, 220, 420), and at least one sealing olive (40) extending around the circumference of the valve, wherein one of the inner and outer parts is adapted for fluid communication with a source of fluid, one of the inner and outer parts is fixed and the other is moveable relative to the fixed part, and the moveable part is arranged to move between a closed position, in which fluid is prevented from reaching the orifice (16) and an open position, in which fluid may be dispensed from the orifice (16) characterised in that the moveable part is free to rotate about its axis, but axial movement is prevented, and in the closed position, the inner part (20, 220, 420) and the outer part (10, 210, 410) are arranged relative to the or each sealing olive (40) to prevent fluid from flowing axially over the sealing olive (40) and through the orifice (16).

Preferably, the sealing olive lies in a plane at and angle to the axes of rotation so that in a first, closed position it prevents fluid from reaching the outlet orifice but in a second open position, the seal lies above the dispensing orifice and therefore, fluid may be dispensed. Thus, the angled circumferential seal allows the valve to achieve its open and closed positions without changing its axial length.

The present invention and its advantages will be better understood by referring, by way of example only, to the following detailed description and the attached Figures, in which;

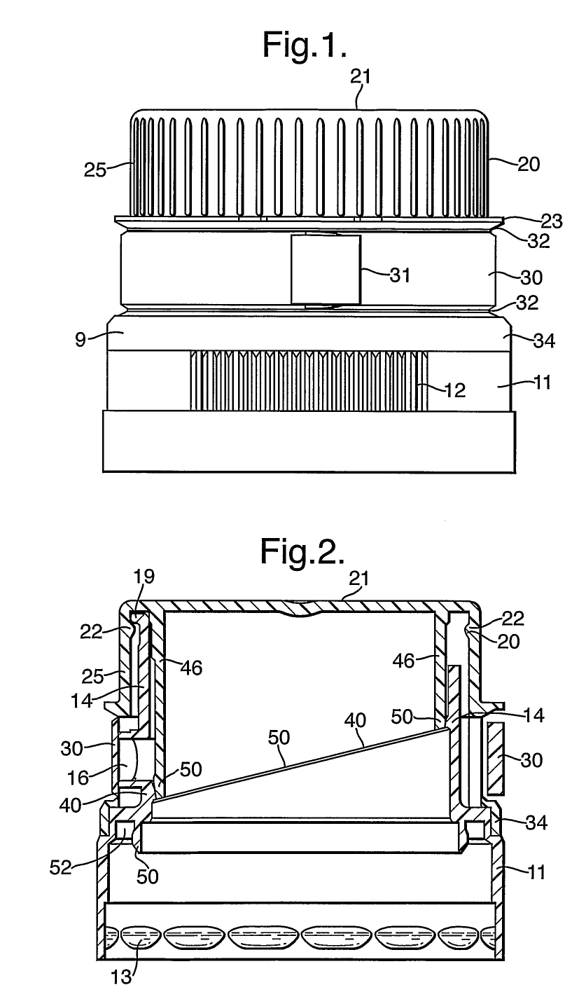

FIG. 1 shows a side-view of a dispensing valve with a tamper evident band in place.

FIG. 2 shows a cross-section through the dispensing valve shown in FIG. 1, with the valve in a fully closed position.

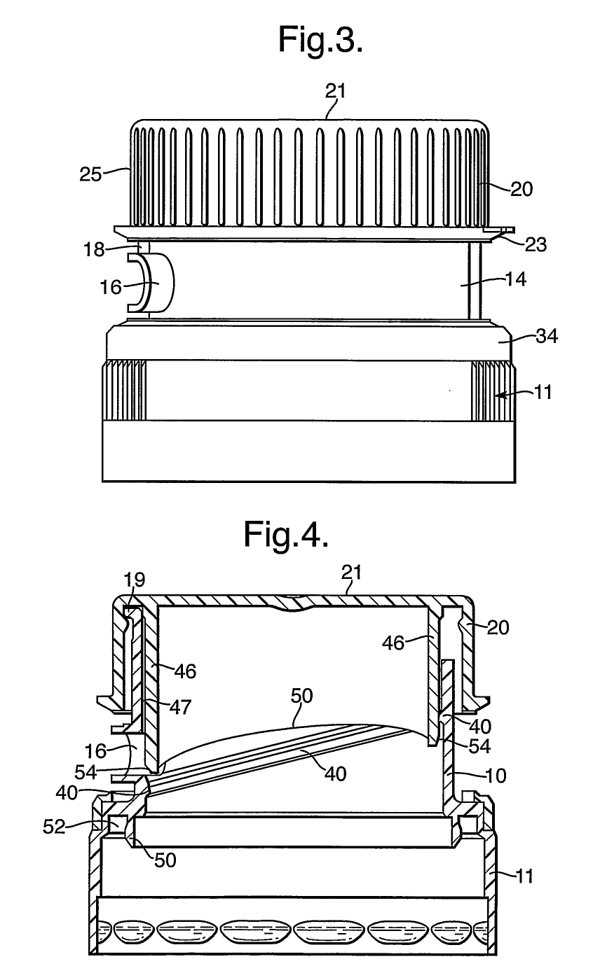

FIG. 3 shows a side-view of the same dispensing valve with no tamper evident band in place.

FIG. 4 shows a cross-section through the dispensing valve shown in FIG. 3 with the dispensing valve in a slightly open position.

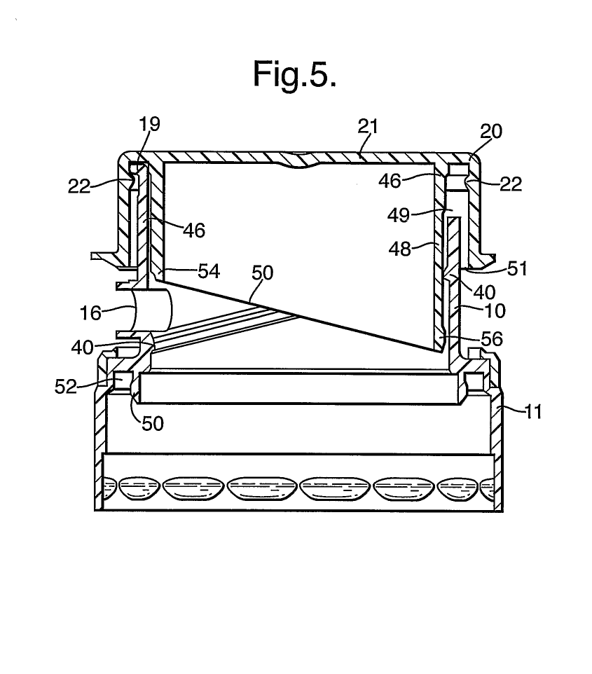

FIG. 5 shows a cross-section through the dispensing valve shown in FIG. 3, with the dispensing valve in a fully open position.

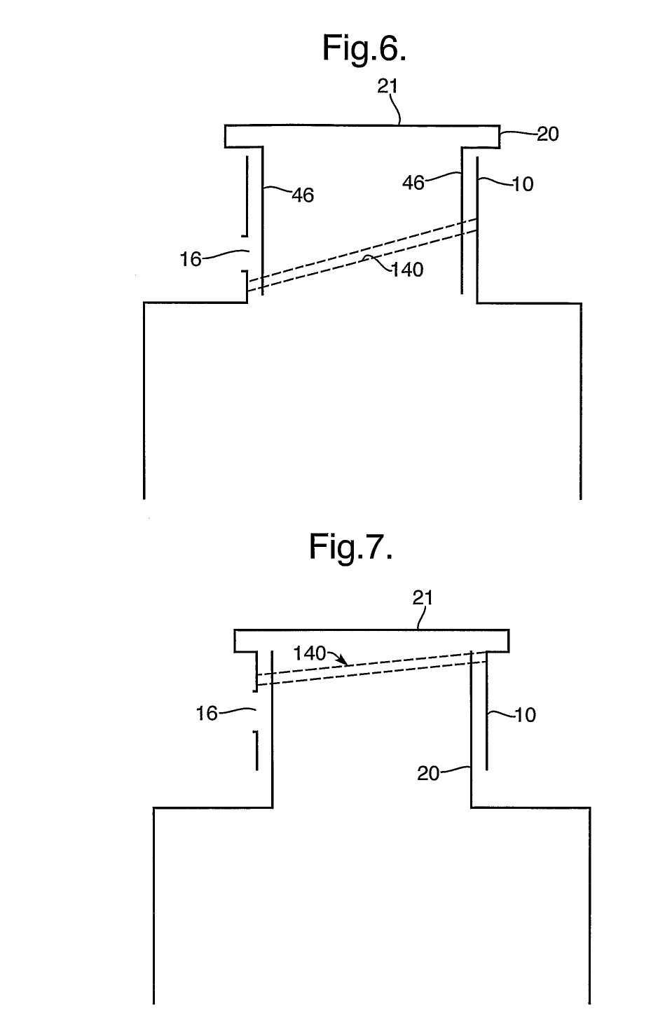

FIG. 6 shows a cross-section through a dispensing valve where the outer part is fixed and the inner part is relatively rotatable.

FIG. 7 shows a cross-section through a dispensing valve where the inner part is fixed and the outer part is relatively rotatable.

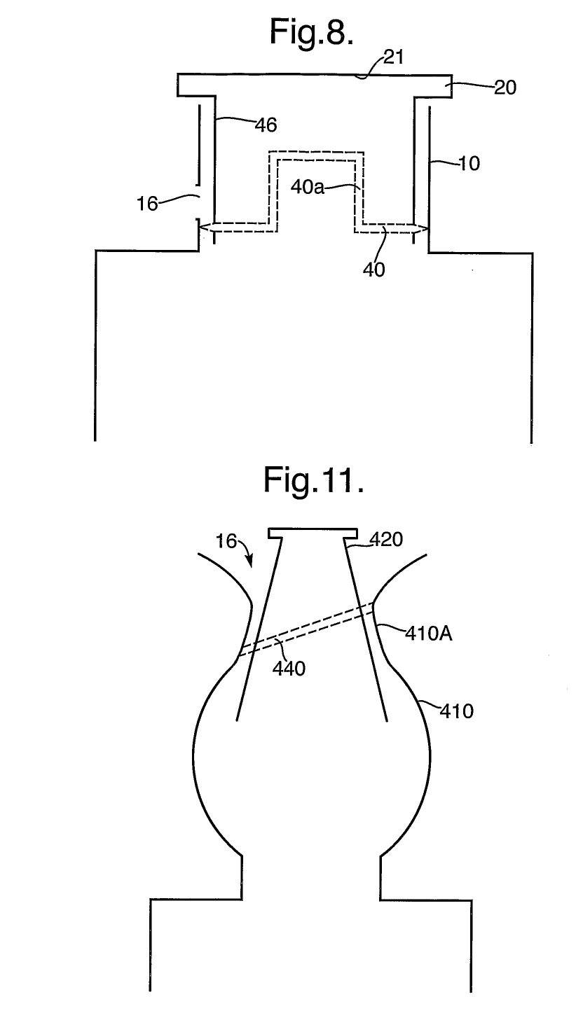

FIG. 8 shows a cross-section through another dispensing valve where the outer part is fixed and the inner part is relatively rotatable.

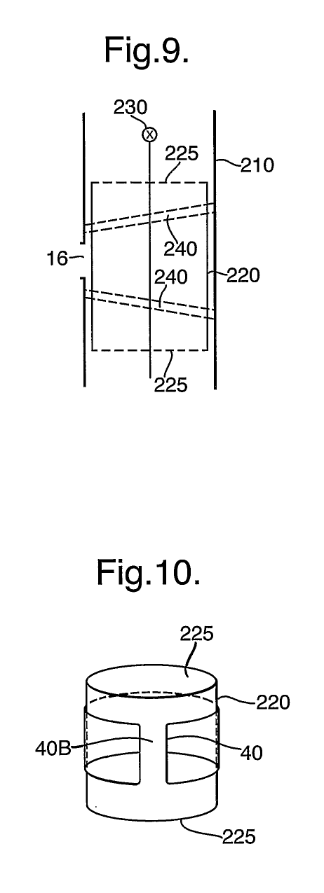

FIG. 9 shows a cross-section through another dispensing valve where the outer part is fixed and the inner part is relatively rotatable and where two olive seals are provided.

FIG. 10 shows view of a variation of the inner part shown in FIG. 9.

FIG. 11 shows a cross-section through a yet further example of a dispensing valve.

In the following description terms such as “upper” and “lower” refer to the views shown in the figures and are not limiting on the orientation of the valve in use. Further, the term “axis of the valve” is hereby defined as the vertical axis as shown in the figures, and is the axis to which the terms “axial”, “radial” and “circumferential” relate.

Referring to FIGS. 1 to 3, the dispensing valve comprises two parts. The first is the fixed outer part 10. This is generally cylindrical and open at both axial ends. One end (the lower end shown in FIG. 1) is fixed to a container. The second part is the moveable inner part 20, which is also generally cylindrical. This fits inside the fixed outer part 10 and is open axially at the lower end. The opposite end is closed by a plate 21, which extends radially outward from the perimeter of the wall 46 of the moveable inner part 20. It also extends radially outward from the wall 14 of the fixed outer part. A skirt 25 depends downwardly from the circumference of this plate 21 so that it forms a wall radially outward from the wall 14 of the fixed outer part. Accordingly, a portion 14 of the fixed outer part 10 is sandwiched between the moveable inner part's inner wall 46 and the moveable inner part's outer skirt wall 25. This outer skirt 25 may be textured for improved grip.

A tamper evident feature 30 in the form of a band is fitted axially around the dispensing valve. The upper edge of this band is joined to the lowest edge 23 of the outer skirt 25. The lower edge of this band is joined to a tamper evident collar 34, which rests on the fixed outer part's shoulder 9. The joins between the lower edge 23 of the skirt 25 and the tamper evident band 30 and between the tamper evident band 30 and the tamper evident collar 34 may comprise frangible bridges 32 which are well known in the art.

Radially inside the tamper evident collar 34 teeth (not shown) are provided which interact with other teeth (also not shown) situated on the radially outward edge of the shoulder 9. These two sets of teeth fit together so that radial movement of the tamper evident collar 34 relative to the shoulder 9 of the fixed outer part 10 is prevented. Thus, the moveable inner part 20 is prevented from being twisted relative to the fixed outer part 10 with the tamper evident band 30 in place since the moveable inner part 20 and the fixed outer part 10 are joined together.

The radial inner face of the tamper evident band 30 covers the spout. To remove the tamper evident band 30 a rip-tab 31 is provided. The user grasps and pulls this rip-tab 31 thus tearing the joins 32 between the tamper evident band 30 and the lower edge 23 of the outer skirt 25 and between the tamper evident band 30 and the tamper evident collar 34 to allow the tamper evident band's 30 removal. Upon removal of the tamper evident band 30, the moveable inner part 20 may be twisted relative to the fixed outer part 10.

Also visible in FIG. 2 is a channel 52 for receiving the neck of the container (not shown). The neck of the container may be screwed into a receiving collar 11 of the fixed outer part 10 by means of screw threads (not shown) located on the inner face of the receiving collar 11 interacting with corresponding screw threads on the outer face of the neck of the container. A bore-seal 51 depends downwardly from the fixed inner part 10 so that it enters the neck of the container (not shown), and thus provides a seal between the container and the dispensing valve in a manner well-known in the art. Alternatively, the container and fixed outer part 10 may not have screw threads. Instead, the two articles may be held together with snap beads 13 which are also well known in the art. If screw threads are employed, as opposed to snap beads, a further tamper evident band (not shown) may be positioned at the base of the fixed outer part 10 so that the container may not be unscrewed without breaking this band thus assuring the customer that the fluid has not been tampered with prior to purchase and subsequent use.

FIG. 3 shows a side view of the dispensing valve after the tamper evident band 30 has been removed. After the removal of the tamper evident band 30 the spout may be seen. This spout surrounds an orifice 16, which passes through the wall 14 of the fixed outer part 10. Above the spout is a projection 18, projecting radially outward from the wall 14 of the fixed outer part 10. This projection 18 acts as a stop to limit rotation of the outer skirt 25 relative to the fixed outer part 10 by blocking the rotational movement of a projection (not shown) located on the inner face of the outer skirt 25.

The interaction between the fixed outer part 10 and the moveable inner part 20 will now be described with reference to FIGS. 3 to 5. A bead 22 located on the radially inner face of the skirt 25 interacts with a flange 19 located on the radially outer face of the wall 14 of the fixed outer part 10. Thus the fixed outer part 10 and the moveable inner part 20 are held together in the well-understood manner of snap-beads. However, flange 19 does not necessarily extend completely around the whole of the cir-cumference of the radially outward face of the fixed outer part 10. The reason for this will be explained later. Further, bead 22 does not necessarily extend completely around the whole of the circumference of the radially inner face of the skirt 25.

On the radially inner face of the wall 14 of the fixed outer part 10 an olive seal 40 is provided which projects radially inward. This seal 40 extends all of the way around the inner circumference of the wall 14. The axial position of this seal 40 varies circumferentially in that it lies in a plane which is angled in relation to the axis of the valve at approximately 80 degrees. Further, the seal 40 is positioned so that the lowest portion, nearest to the container, lies approximately adjacent to the orifice 16 and between the orifice 16 and the container. The uppermost portion of the seal 40, furthest from the container, lies at a point, which is approximately diametrically opposite radially from the orifice 16.

The inner moveable part 20 comprises a generally cylindrical wall 46, which downwardly depends from the plate 21. This plate 21 blocks the one axial end of the moveable inner part 20. This generally cylindrical wall 46 is of varying axial length so that its lower end 50 lies in a uniform plane, which is angled to the axis of the dispensing valve by approximately 80 degrees. When the dispensing valve is in the fully closed position, the moveable inner part 20 is positioned so that the lower end 50 of the wall 46 is lying circumferentially coincident with the seal 40. The lower end 50 of the wall 46 contacts the seal 40 so that interference is created therebetween. This may be achieved, for instance, by the seal 40 squeezing the lower end 50 of the wall 46 radially inwards, or vice-versa. This interference creates a fluid-tight seal.

Further, the very end 50 of wall 46 may be reduced in diameter to create a shaped edge 54 (refer to FIGS. 4 and 5). This shaped edge 54 is provided circumferentially about the outer radial face of the wall 46 so that this end of the outer face of the wall 46 has a diameter less than the outer face of the wall 46 above. The purpose of this shaped edge will be explained in more detail below.

With the dispensing valve in the closed position, fluid held within the container may not pass through the orifice 16 nor axially over the seal 40 since the wall 46, together with plate 21, are blocking its passage and the lower end 50 of the wall 46 is sealed against the seal 40.

Although an angle of 80 degrees to the axis of the dispensing valve has been described for the seal 40 and the lower end 50 of the wall 46, other angles are possible. The only limitation is that the orientation of the olive seal 40 and lower end 50 of wall 46 must allow fluid to flow axially over the seal 40 when the moveable inner part 20 has been rotated relative to the fixed outer part 10 away from the closed position. Further examples of the orientation of the olive seal 40 and lower end 50 of wall 46 are given below.

In FIG. 4, the dispensing valve is partially open. This has been achieved by rotational movement of the moveable inner part 20 relative to the fixed outer part 10. As may be seen, since the two parts 10,20 have been rotated relative to one another, although the seal 40 on the inner face of the fixed outer part 20 has remained stationary relative to the container, the lower end 50 of the wall 46 of the moveable inner part 20 has moved so that it is no longer coincident with the seal 40. Accordingly there is now no sealing effect between the lower end 50 of the wall 46 and the olive seal 40. Accordingly, fluid held in the container may pass axially over the olive seal 40 and travel around the radially outer face of the wall 46 in the narrow gap 47, which exists between this outer face and the radially inner face of the fixed outer part 10. Such fluid may then reach the orifice 16 and be dispensed. This may occur even though the wall 46 still covers the entire area of the orifice 16. This is because there is no sealing effect between the outer face of the wall 46 and the orifice 16.

As the moveable inner part 20 is rotated further, the wall 46 is drawn away from behind the orifice 16 so that not only may fluid pass along the gap 47 between the wall 46 and the fixed outer part 10 but it may also travel directly from the container to the orifice without hindrance. Such a situation is exemplified in FIG. 5.

FIG. 5 also shows that the wall 14 of the fixed outer part has another orifice in the form of a cut-out section at its uppermost end and on the circumferential portion approximately opposite to the orifice 16. Accordingly, flange 19 does not necessarily extend completely around the whole of the perimeter of the radially outward face of the fixed outer part 10, as described above. Also, the wall 46 of the moveable inner part 20 has a portion of reduced thickness 48. The cut-out portion of wall 14 and the reduced thickness portion 48 of wall 46 overlap axially so as to create a gap 49. Accordingly, when fluid is being dispensed via the orifice 16, air may enter the dispensing valve and thus the container via the following route. Firstly, air may enter through a gap 51 located between the moveable outer part 20 and the fixed inner part 10. It then may pass over the top of the fixed inner part 10 and through the gap 49. From here, air may then travel through the space between the fixed inner part 10 and the wall 46 of the moveable inner part 20 by means of the reduced thickness portion 48. Finally, air may then travel into the inner space within the dispensing valve and thus into the container. The advantage of this route is to allow the free passage of air to reduce or eliminate so-called “glugging” and improve the smooth flow of the fluid as it is dispensed.

With regard to the seal 40, it has already been described how the very end of the wall 46 has a shaped edge 54. This shaped edge 54 produces the advantage that the lower end 50 of the wall 46 may be brought into contact with, and moved away from, the olive seal 40 in a smooth manner. This smooth manner is further enhanced by the nature of typical olive seals, which have a rounded profile. This rounded profile thus provides a lead-in edge (not shown) on the upper edge of olive seal 40. It is the combination of the shaped edge 54 in conjunction with this lead-in edge that enhances the smooth manner in which the interference of the olive seal 40 with the lower end 50 of wall 46, and thus the sealing effect, may be increased and decreased. For example, the lower end 50 of wall 46 or olive seal 40 may move from a compressed state to an uncompressed state in a smooth manner.

A further advantage of the embodiment described above is that with the olive seal 40 and the end of the wall 50 angled to the axis of the valve, as the user opens the valve, by rotating the moveable part relative to the fixed part, the resistance created by the interference between the olive seal and wall end 50 reduces. This is because by rotation of the two parts relative to one another, the seal 40 and wall end 50 move away from each other axially so that there is less contact between the two and hence less friction.

Although the above embodiment has been described with the olive seal 40 lying on the radially inner surface of the outer part 10 interacting with the end of the wall 50 of the inner part 20 to produce a sealing effect, it would also be possible to have a seal on the radially outer surface of the inner part. This seal could be in the form of another olive seal and would interact with the olive seal 40 on the fixed part 10. This seal would be moved into and out of contact with the olive seal 40 in the same manner as described above with reference to the end of the wall 50. Such an embodiment is shown in FIG. 6, where it may be seen that since the sealing effect is provided by corresponding seals 140 on both of the inner and outer parts there is no need for the lower end of the inner depending wall 46 to lie in a plane parallel with the sealing zone 140.

FIG. 7 shows a further embodiment wherein the inner part 20 is fixed and the outer part 10 is moveable relative to the fixed part 20. The outer part has an end plate 21 and at least one orifice 16 is provided in the wall, which depends downwardly from this end plate 21. A seal zone 140 is created by having, for instance, seals on the radially inner surface of the moveable outer part and the radially outer surface of the fixed inner part, which interact to produce a sealing effect in the same manner as described above.

When the user wishes to dispense fluid from the container (unreferenced), the outer part 10 is rotated relative to the inner part 20 so that the sealing effect is disrupted at the sealing zone 140. Accordingly, fluid may then flow over the top of the inner wall in a weir-like manner and axially over the seals to reach the at least one orifice 16, when fluid is brought into contact with the dispensing valve by either tipping or squeezing of the container.

It would also be possible to produce a dispensing valve wherein the lower end of the depending wall of the outer part lies in the same plane as a seal on the radially inner wall of the outer part 120 so that they interact together in the same manner as described with reference to FIGS. 1 to 5. This would remove the need for a separate seal on the radially inner surface of the outer part 120. This embodiment is not shown in the figures. The end of the wall of the outer part may also be chamfered.

FIG. 8 shows an embodiment wherein the outer part 10 is fixed, the inner part 20 is moveable relative to the fixed part, and the inner part 20 has an end plate 21 in a similar manner to the embodiment shown in FIGS. 1 to 4. In this embodiment a seal 40 is provided on the radially outer face of the moveable inner part 20. This seal 40 is pressed against the radially inner surface of the fixed outer part 10 to create a fluid-tight seal. However, this seal 40 does not lie in a uniform plane all about the cir-cumference. Rather, the seal 40 has most of its length lying in a plane which is below the orifice 16 but also includes a section 40a which rises above the lower level of the at least one orifice 16. When the inner part 20 is in a position such that this section 40a of seal 40 is radially completely out of alignment with the orifice 16, no fluid can pass axially over the seal 40 and through the orifice 16. Accordingly, fluid may not be dispensed via the orifice 16 from a container connected to the fixed part 10. When the inner part 20 is rotated relative to the fixed outer part 10 and the section of seal 40a either overlies the orifice 16 or surrounds it, fluid may pass from the container to the orifice 16.

Although only one section 40a of the seal 40 has been shown to deviate from the depicted horizontal section, there may of course be other sections which also do this and which also may be brought into correspondence with orifices.

As discussed earlier, the invention may not be limited to use with conventional bottles but may also be used with pipes and other fluid retaining structures. FIG. 9 shows an example of this. In this figure, a pipe has a fixed outer part 210 with at least one orifice 16. A moveable inner part 220 is provided. In this example this inner part may be rotated by means of a motor 230, although other forms of rotation will be evident to those skilled in the art.

Two sealing zones 240 are created, one axially either side of the orifice 16. These zones are created by olive-type seals lying on the radially outer surface of the moveable inner part 220 interacting with two corresponding olive-type seals lying on the radially inner surface of the fixed outer part 210. These seals are shown as lying in two uniform planes inclined to the horizontal. However, they do not necessarily have to lie in uniform planes, as long as in at least one rotational position the seals on the inner and outer parts align and interact to provide a fluid-tight seal, and further, when the moveable inner part 220 is rotated relative to the fixed outer part 210 the interaction of the seals is disrupted. When the seals are in full correspondence about the circumference of the pipe 210, no fluid may pass from inside of the pipe 210, axially over the seals and through the orifice 16. However, when the sealing effect is disrupted by relative rotation fluid may pass axially over the seals and via the orifice 16.

The moveable inner part has two axial ends 225. These ends may be either closed or open. If the ends are closed then when the inner 220 and outer 210 parts are in a rotational position relative to one another such that a sealing effect is created, no fluid may not only pass through the orifice 16 but may also not pass axially along the pipe 210 from one side to the other of the inner part 210.

Further, the sealing zones 240 could be arranged such that when the upper zone has a sealing effect the lower zone is disrupted so that fluid may flow from the lower end of the pipe 210 through the orifice 16 and vice versa. This could be used to alternately dispense two fluids each having their source at opposite ends of the pipe 210.

To reduce the number of seals from four, in the above embodiment, to one, FIG. 10 shows a further embodiment. In this figure only the moveable inner part 220 is shown. It has one seal 40 in the shape of a lower, almost completely circumferential, plane and an upper, also almost completely circumferential, plane. These two planes are connected together so that both left hand ends of the upper and lower planes are connected and both right hand ends are connected. A gap 40B is thus created in the seal so that a quadrant of the circumference of the radially outer surface of the inner part 220 has no seal. The seal 40 is, however, continuous.

There is no need for a further seal on the radially inner surface of the fixed outer part 210, although this is possible, since the seal 40 is pressed against the inner surface of the pipe 210 to produce the sealing effect between inner and outer parts.

When the inner part 220 is in at least one rotational position relative to the pipe 210, the orifice 16 will lie in a portion between the upper and lower planes of the seal 40 and radially completely out of alignment with the gap 40B. Accordingly no fluid within the pipe 210 may pass axially over the seal 40 and through the orifice 16. Conversely when the inner part 220 is rotated relative to the pipe 210 there will come a point where the orifice overlies the seal 40 or is situated completely inside the gap 40B. At this point fluid may pass through the orifice 16.

Although all of the above description and referenced figures have been in relation to two cylinders which are co-axially fitted one inside the other, it should be apparent that the inner and outer parts do not necessarily have to take this form. FIG. 11 shows a fixed outer part 410 of varying cross-sectional shape (a spherical main body surmounted by a widening mouth part with a neck portion 410A axially there between) and a moveable inner part 420 also of varying cross-sectional shape (a frusto-conical asymmetric form).

A sealing zone 440 is provided between the radially outer surface of the inner part 420 and the radially inner surface of the outer part 410. This sealing zone may be created by olive seals lying on at least one of these two surfaces as described above with reference to FIGS. 1 to 8. The lower end of the wall of the inner part 420 may also be used to produce the sealing effect in conjunction with one olive seal as described above with reference to FIGS. 1 to 5. Rotation of the inner part 420 relative to the outer part 410 disrupts the sealing effect and allows fluid to pass through orifice 16.

Accordingly, it is apparent that the only requirement of the shape of the two parts is that they allow relative rotation there between. This rotational movement need not be 360 degrees. In fact rotation by only a few degrees would be sufficient to disrupt the seal.

One possibility that also needs to be mentioned is that of the two parts having an oval shape (in plan view). At first sight it might be thought that these two shapes would not allow relative rotational movement. However, if the material of which at least one of the parts consists has a resilient nature, it would be possible for the moveable part to rotate between two bistable positions. Once this concept is understood it will become apparent that other shapes are equally possible.

Further, in the above embodiments it has been explained that olive seal 40 could interact with a second seal, possibly in the form of another olive seal. However, this second seal could in fact be a stepped portion on the surface of one of the corresponding walls.

Further still, the above description has been primarily phrased from the point of view of the dispensing valve allowing fluid to pass radially through an orifice. However, it should be understood that the container, bottle or pipe could in fact have a vacuum present inside. Accordingly, the valve would not be dispensing in the sense that fluid flows radially outwards, but rather that it controls fluid entering the container, bottle or pipe to fill the vacuum.

Yet further, all of the above described embodiments allow the flow of fluid to be regulated by relative movement of one part to another. This flow may be regulated from none to a maximum and vice versa.

Even further, the orifices could be in the form of a group of relatively small holes or of several relatively large holes. This would enable a user to choose between different types of dispensing such as sprinkling or pouring.

In one particular use, the dispensing valve may be attached to a container, which lies on its side so that the dispensing valve is located at right angles to that shown in the figures. In such a case, the orifice would be located on the lowest side of the dispensing valve for optimum operation. An example of use of the above described dispensing valve is with a five litre bottle of water, which may be kept in a refrigerator on its side. When the user wishes to dispense water, once the tamper evident band has been removed, they merely need to place a receptacle underneath the orifice and rotate the moveable part of the dispensing valve to dispense the required amount, reversing the movement afterwards to close the dispensing valve. This means that a user only needs one hand to operate the dispensing valve, so that the other hand may be used to hold the receptacle. Further, because of the smooth nature of rotation and of the sealing and unsealing action, a smooth and controlled flow of fluid from none to the desired maximum, without any sudden movement or jerking of the container, which can often lead to spillage, may be achieved.

Although this example has been given of use of the dispensing valve with container holding water, other fluids may of course be dispensed such as granules.

It would also be possible to include an indexing system to the dispensing valve so that the rotation of the moveable part relative to the fixed part may be determined more effectively. Such a system could be achieved by means of interacting and radially opposing projections located on the fixed part and the moveable part. These projections could also be designed to produce a click, which may be both felt and heard by the user as the moveable part is rotated relative to the fixed part. In the same manner, the dispensing valve could be designed so that a click may be heard and felt by the user when the dispensing valve is correctly and fully opened or closed to provide a positive identification.

1-9. (canceled)

10. A valve for use as a fluid flow regulator, comprising:
an outer part having at least one orifice;
an inner part; and
at least one sealing olive extending around the circumference of the valve, wherein one of the inner and outer parts is adapted for fluid communication with a source of fluid, one of the inner and outer parts is fixed and the other is moveable relative to the fixed part, and the moveable part is arranged to move between a closed position, in which fluid is prevented from reaching the orifice and an open position in which fluid may be dispensed from the orifice, characterized in that the moveable part is free to rotate about its axis, but axial movement is prevented, and in the closed position, the inner part and the outer part are arranged relative to each sealing olive to prevent fluid from flowing axially over the sealing olive and through the orifice.

11. A valve according to claim 10, wherein the at least one sealing olive lies in a plane at an angle of less than 90 degrees to the axes of rotation.

12. A valve according to claim 10 or claim 11, wherein the axial position of the at least one sealing olive varies circumferentially.

13. A valve according to claim 10 or claim 12, wherein the inner part is rotatable and the outer part is fixed.

14. A valve according to claim 13, wherein the inner part comprises a wall which is closed at one axial end and is open at another lower end, the at least one sealing olive being arranged on an internal surface of the outer part and the lower end of the wall of the inner part being shaped circumferentially so that it is substantially coincident with the axial position of the sealing olive, when the inner and outer parts are in the closed position.

15. A valve according to claim 13 or claim 14, wherein the internal surface of the outer part and the external surface of the inner part each have at least one sealing olive, each said sealing olive being arranged to be substantially coincident when the inner and outer parts are in the closed position.

16. A valve according to claim 10, claim 12, claim 13, claim 14 or claim 15, wherein a sealing olive is provided axially of either side of the at least one orifice.

17. A valve according to claim 16, wherein the outer part defines at least two fluid pathways, one pathway via the orifice for dispensing fluid and one pathway defining a venting gap.

18. A dispensing valve for a container, comprising:
a fixed part;
a movable part sealingly rotatable with respect to the outer part, the fixed part being attachable to a container and including an orifice, wherein the movable part is axially fixed relative to the fixed part and includes a wall, the movable part being rotatable relative to the fixed part between a closed position, in which fluid is prevented from reaching the orifice by the wall, and an open position, in which fluid may be dispensed from the orifice, the wall having a varying axial length with a free end, which lies in a uniform plane and which is angled to the axis of the valve, such that rotation of the movable part away from the closed position draws the angled wall away from the orifice to allow regulation of flow from a container in use.

19. A dispensing valve according to claim 18, wherein the fixed part is an outer part and the movable part is an inner part rotatable within the outer part, such that rotation of the movable part away from the closed position draws the angled wall away from behind the orifice to allow regulation of flow.
